(19) United States
(12) Patent Application Publication
(10) Pub. No.: US 2015/0024717 A1
(43) Pub. Date: Jan. 22, 2015

(54) METHOD OF A DATA CHANNEL TELEPHONE NETWORK SYSTEM

(71) Applicant: FLYPSI, INC., Tucson, AZ (US)

(72) Inventors: Sunir Kochhar, Porter Ranch, CA (US); Ivan Zhidov, Chickasha, OK (US)

(73) Assignee: FLYPSI, INC., Tucson, AZ (US)

(21) Appl. No.: 13/944,853

(22) Filed: Jul. 17, 2013

(51) Int. Cl. H04W 4/16; H04W 4/06; H04M 1/725; H04W 4/12

(52) U.S. Cl. CPC H04W 4/16; H04W 4/12; H04W 4/06; H04M 1/72597
USPC 455/413; 455/414.1; 455/416; 455/415; 455/564

(57) ABSTRACT

The embodiments disclose a method of a data channel telephone network system including enrolling a user subscribing to a data channel telephone network system, installing a data channel telephone network application on user telephone handset, using the data channel telephone network application to record and store user selectable and configurable call processing rules on the network database, routing incoming and outgoing calls via a public switched telephone network to the data channel telephone network system using the user configured call processing rules and displaying choices the user can choose from to process how to handle an incoming call response using user configured call processing rules, user preset responses and data channel telephone network application automated features.

### BACKGROUND

The volume of telephone calls and text messaging has increased dramatically and users are finding it more and more difficult to manage that volume of calls and messages. The current systems to aid in managing some types of calls only provide minimal assistance to the user.

### BRIEF DESCRIPTION OF THE DRAWINGS

FIG. 1 shows a block diagram of an overview of a method of a data channel telephone network system of one embodiment.

FIG. 2 shows a block diagram of an overview flow chart of a method of a data channel telephone network system of one embodiment.

FIG. 3A shows for illustrative purposes only an example of a method of a data channel telephone network system incoming call processing of one embodiment.

FIG. 3B shows for illustrative purposes only an example of a method of a data channel telephone network system outgoing call processing of one embodiment.

FIG. 4 shows a block diagram of an overview flow chart of call processing rules of one embodiment.

FIG. 5 shows a block diagram of an overview flow chart of incoming pre-call information of one embodiment.

FIG. 6 shows a block diagram of an overview flow chart of user handset application conference calling feature of one embodiment.

FIG. 7 shows a block diagram of an overview flow chart of Data channel telephone network layers of one embodiment.

FIG. 8A shows a block diagram of an overview flow chart of handset application of one embodiment.

FIG. 8B shows a block diagram of an overview flow chart of call processing user choices of one embodiment.

FIG. 9 shows a block diagram of an overview flow chart of provisioning of service of one embodiment.

FIG. 10 shows a block diagram of an overview flow chart of incoming calls of one embodiment.

FIG. 11 shows a block diagram of an overview flow chart of outgoing calls of one embodiment.

FIG. 12 shows a block diagram of an overview flow chart of handset application custom voice mail features of one embodiment.

FIG. 13 shows a block diagram of an overview flow chart of commercial entity provisioning of service of one embodiment.

FIG. 14 shows a block diagram of an overview flow chart of commercial entity incoming calls of one embodiment.

FIG. 15 shows a block diagram of an overview flow chart of commercial entity outgoing calls of one embodiment.

FIG. 16 shows a block diagram of an overview flow chart of commercial entity assignable multiple alternative telephone number calling features of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

General Overview:

It should be noted that the descriptions that follow, for example, in terms of a method of a data channel telephone network system is described for illustrative purposes and the underlying system can apply to any number and multiple types of telephone network systems. In one embodiment of the present invention, the data channel telephone network system can be configured using a user telephone handset application. The data channel telephone network system can be configured to include a network Layer and can be configured to include an application layer using the present invention.

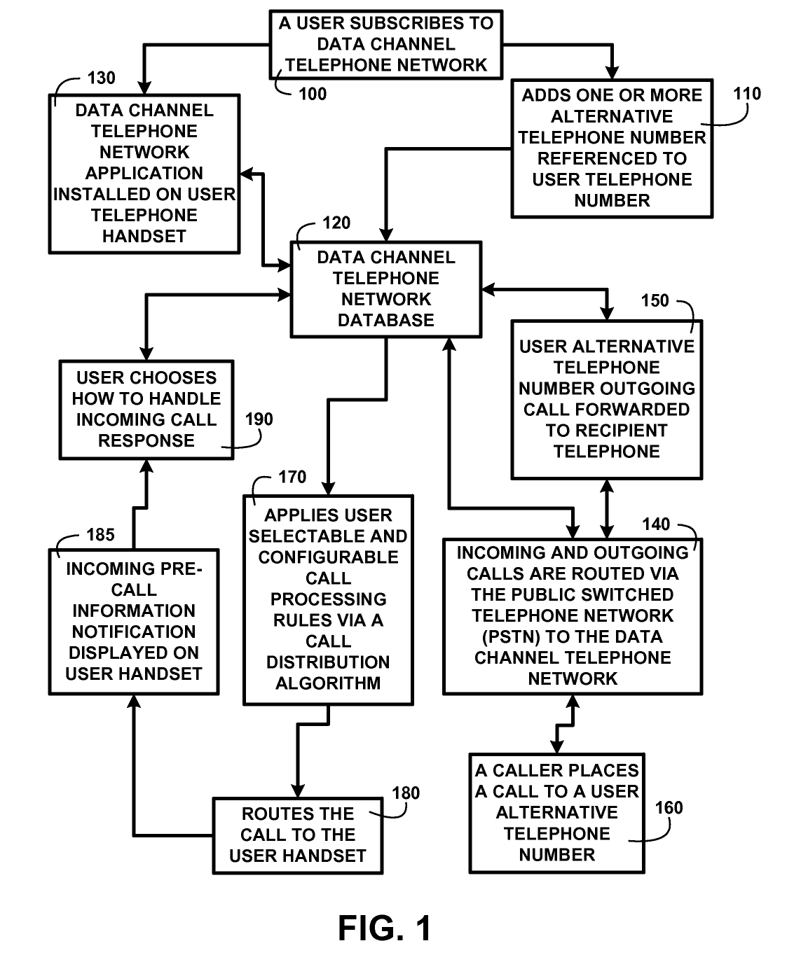

FIG. 1 shows a block diagram of an overview of a method of a data channel telephone network system of one embodiment. FIG. 1 shows a user subscribes to data channel telephone network 100. The user adds one or more alternative telephone number referenced to user telephone number 110 in a data channel telephone network database 120. The user downloads a data channel telephone network application. The data channel telephone network application installed on user telephone handset 130 connects the user through the user handset telephone to the data channel telephone network database 120. The user can place a call using a user alternative telephone number outgoing call forwarded to recipient telephone 150. The user receives incoming calls through the data channel telephone network database 120 and data channel telephone network application installed on user telephone handset 130. A caller places a call to a user alternative telephone number 160. Both incoming and outgoing calls are routed via the public switched telephone network (PSTN) to the data channel telephone network 140 of one embodiment.

The data channel telephone network database 120 applies user selectable and configurable call processing rules via a call distribution algorithm 170 and routes the call to the user handset 180. Incoming pre-call information notification displayed on user handset 185 enables a method wherein a user chooses how to handle incoming call response 190 of one embodiment.

Detailed Description:

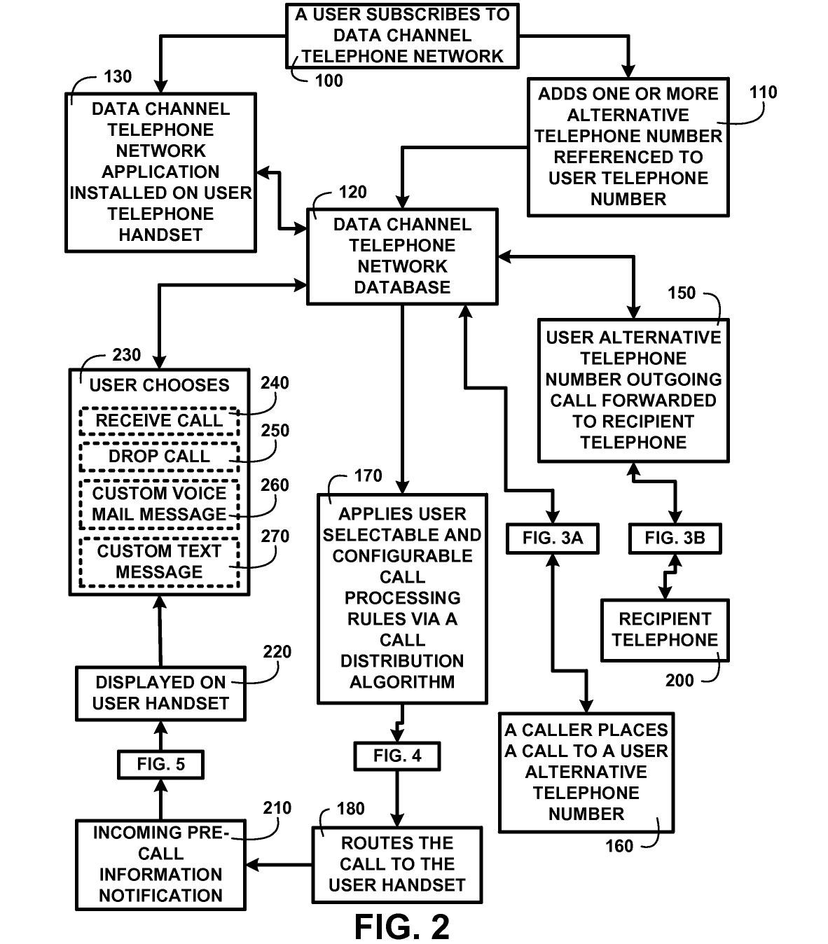

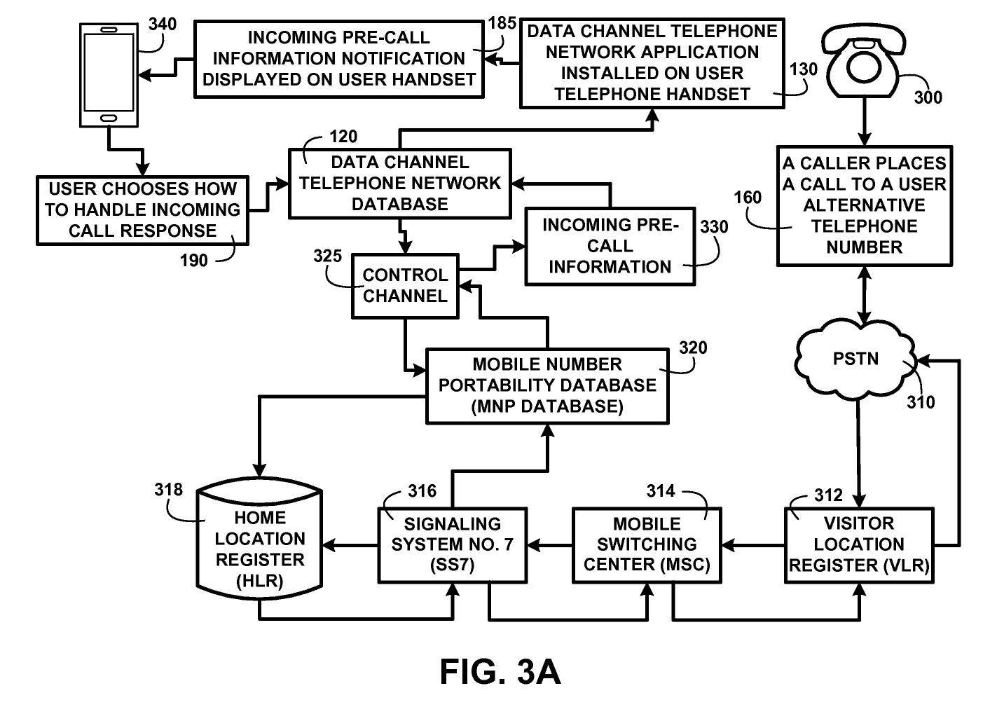

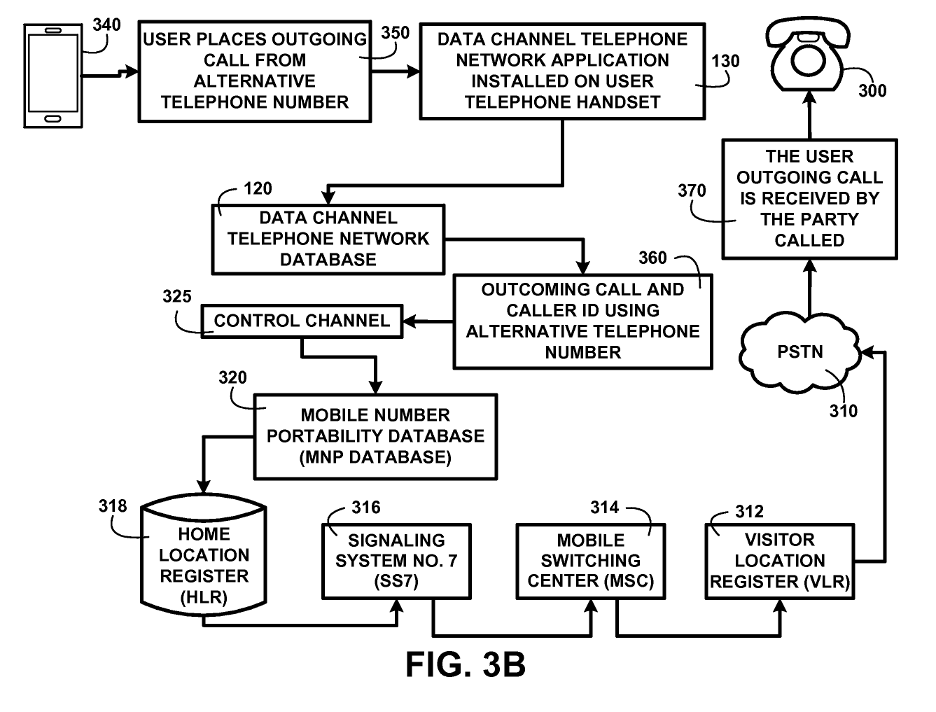

FIG. 2 shows a block diagram of an overview flow chart of a method of a data channel telephone network system of one embodiment. FIG. 2 shows a user subscribes to data channel telephone network 100 and adds one or more alternative telephone number referenced to user telephone number 110 on the data channel telephone network database 120. The data channel telephone network application installed on user telephone handset 130 is used to connect to the data channel telephone network database 120. An incoming call is processed as described in FIG. 3A when a caller places a call to a user alternative telephone number 160. A user alternative telephone number outgoing call forwarded to recipient telephone 150 is described in FIG. 3B of one embodiment.

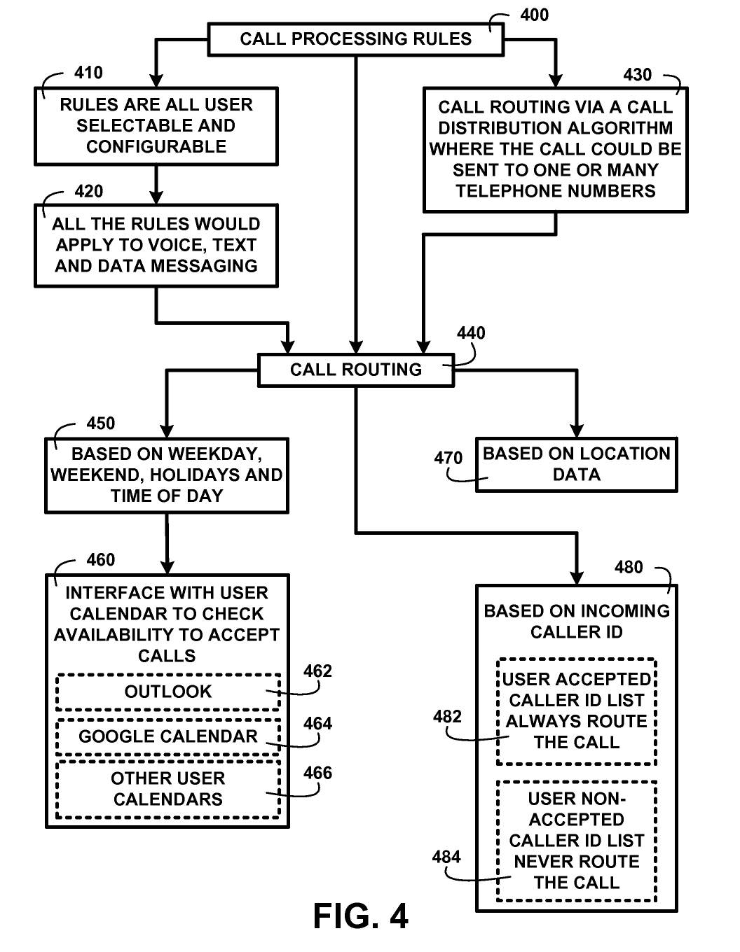

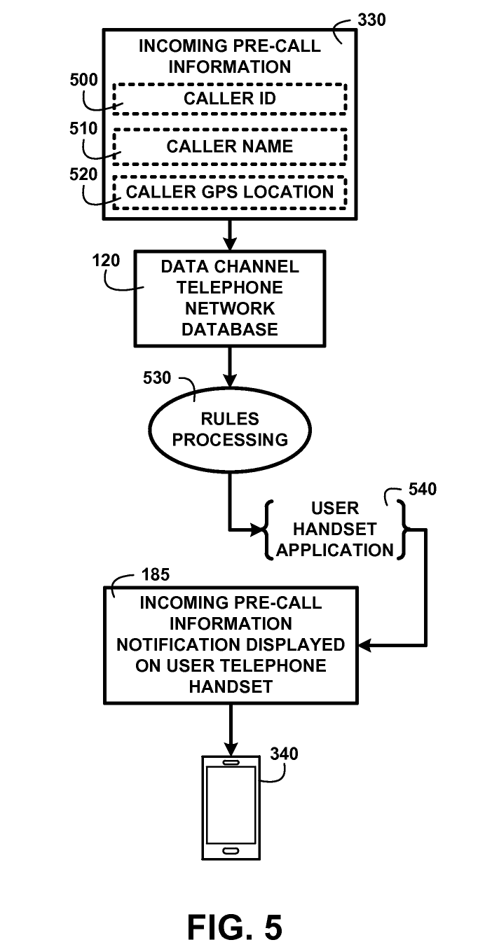

Both incoming calls and outgoing calls to a recipient telephone 200 are processed according to user call processing rules. The data channel telephone network database 120 applies user selectable and configurable call processing rules via a call distribution algorithm 170 as described in FIG. 4. The data channel telephone network database 120 processes an incoming call and routes the call to the user handset 180 including incoming pre-call information notification 210 as described in FIG. 5 and the incoming pre-call information notification 210 is displayed on user handset 220. A user chooses 230 to receive call 240, drop call 250, play a custom voice mail message 260 or send a custom text message 270 of one embodiment.

Incoming Call Processing:

FIG. 3A shows for illustrative purposes only an example of a method of a data channel telephone network system incoming call processing of one embodiment. FIG. 3A shows a caller telephone 300 used when a caller places a call to a user alternative telephone number 160. The user incoming call is routed from the caller telephone 300 to a PSTN 310. The PSTN 310 routes the call through a visitor location register (VLR) 312, mobile switching center (MSC) 314, signaling system no. 7 (SS7) 316 and home location register (HLR) 318. During the call routing through the signaling system no. 7 (SS7) 316 the data portion of the call is routed to a mobile number portability database (MNP database) 320 and control channel 325. Incoming pre-call information 330 is received by the data channel telephone network database 120 before or during the call ringing on the user telephone handset. The data channel telephone network application installed on user telephone handset 130 receives and processes the Incoming pre-call information 330. The incoming pre-call information notification displayed on user handset 185. The user can see the pre-call information in anticipation of receiving the call to the user telephone handset 340 using the alternative telephone number. The user chooses how to handle incoming call response 190 of one embodiment.

The data channel telephone network database 120 processes the user choice and transmits the user instruction through the control channel 325, mobile number portability database (MNP database) 320, home location register (HLR) 318, signaling system no. 7 (SS7) 316, mobile switching center (MSC) 314 and visitor location register (VLR) 312 to the PSTN 310 where a caller places a call to a user alternative telephone number 160 using a caller telephone 300. The PSTN 310 can for example be instructed following the user choice to drop the call or complete the connection to enable the user to receive the call of one embodiment.

Outgoing Call Processing:

FIG. 3B shows for illustrative purposes only an example of a method of a data channel telephone network system outgoing call processing of one embodiment. FIG. 3B shows user telephone handset 340 wherein a user places outgoing call from alternative telephone number 350. The user uses the data channel telephone network application installed on user telephone handset 130. The data channel telephone network database 120 processes the outgoing call and caller ID using alternative telephone number 360. The data channel telephone network database 120 routes the outgoing call through the control channel 325 to the mobile number portability database (MNP database) 320 and automatically through the home location register (HLR) 318, signaling system no. 7 (SS7) 316, signaling system no. 7 (SS7) 316, mobile switching center (MSC) 314 and visitor location register (VLR) 312 to the PSTN 310. The user outgoing call is received by the party called 370 on a caller telephone 300 of one embodiment.

Call Processing Rules:

FIG. 4 shows a block diagram of an overview flow chart of call processing rules of one embodiment. FIG. 4 shows call processing rules 400 including call routing via a call distribution algorithm where the call could be sent to one or many telephone numbers 430. Rules are all user selectable and configurable 410 and all the rules would apply to voice, text and data messaging 420. The processing rules 400 include call routing 440 based on location data 470, based on incoming caller ID 480 using a user accepted caller ID list always route the call 482 and a user non-accepted caller ID list never route the call 484 of one embodiment.

The processing rules 400 include call routing 440 based on weekday, weekend, holidays and time of day 450, based on an interface with user calendar to check availability to accept calls 460 including for example Outlook 462, Google Calendar 464 and other user calendars 466 of one embodiment.

Incoming Pre-Call Information:

FIG. 5 shows a block diagram of an overview flow chart of incoming pre-call information of one embodiment. FIG. 5 shows incoming for example pre-call information 330 including caller ID 500, caller name 510 and caller GPS location 520. The pre-call information 330 is sent from the data channel telephone network database 120 after rules processing 530 to a user handset application 540. The incoming pre-call information notification displayed on user handset 185 using the handset application installed on the user telephone handset 340 of one embodiment.

User Handset Application Conference Calling Feature:

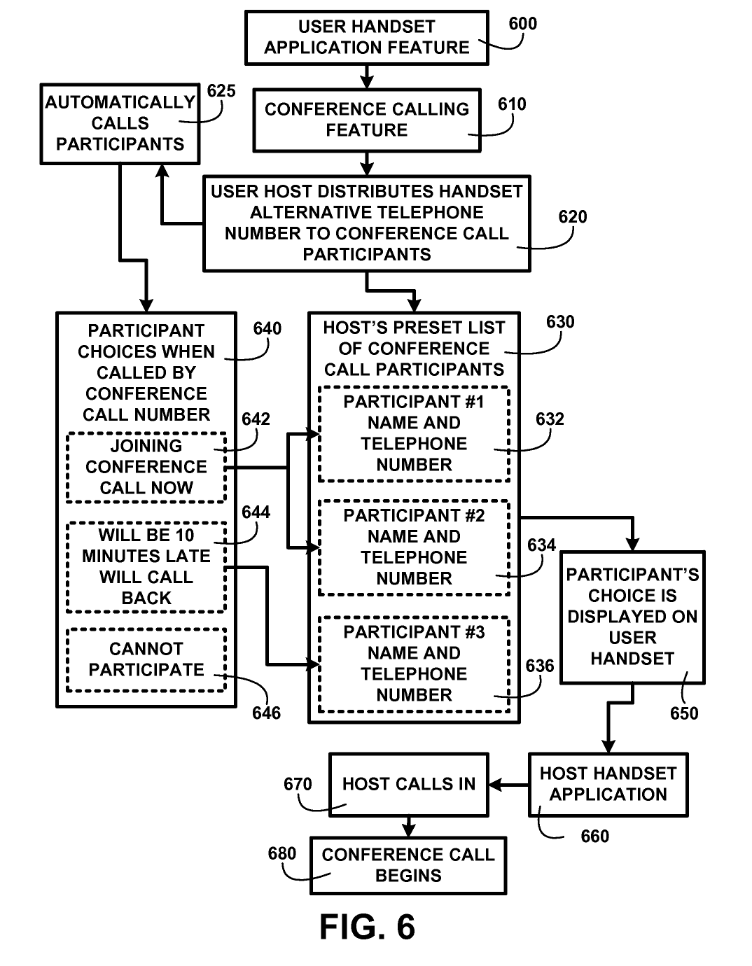

FIG. 6 shows a block diagram of an overview flow chart of user handset application conference calling feature of one embodiment. FIG. 6 shows a user handset application feature 600 including a conference calling feature 610. The conference calling feature 610 wherein a user host distributes handset alternative telephone number to conference call participants 620. The user creates a host's preset list of conference call participants 630 for example participant #1 name and telephone number 632, participant #2 name and telephone number 634 and participant #3 name and telephone number 636. The conference calling feature 610 automatically calls participants 625 to poll their availability for the conference call. The conference calling feature 610 displays participant choices when called by conference call number 640 including for example joining conference call now 642, will be 10 minutes late will call back 644 and cannot participate 646. A participant's choice is displayed on user handset 650 using the host handset application 660. When the participants are on the conference call a host calls in 670 and the conference call begins 680 of one embodiment.

Data Channel Telephone Network Layers:

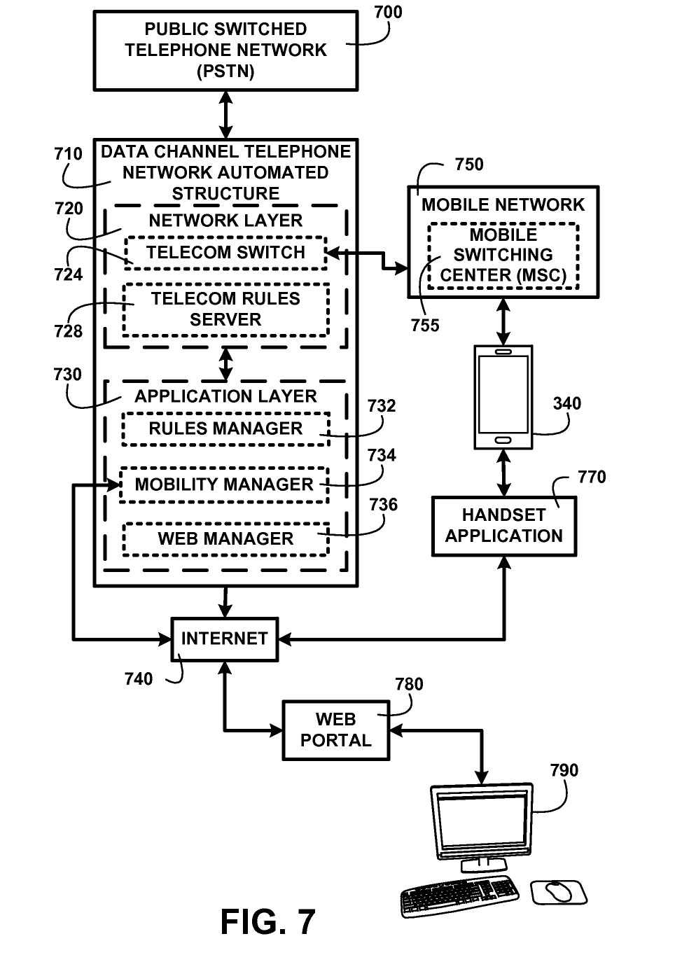

FIG. 7 shows a block diagram of an overview flow chart of data channel telephone network layers of one embodiment. FIG. 7 shows a data channel telephone network system including layers that make up the system structure for automatically interacting with a public switched telephone network (PSTN) 700. The data channel telephone network automated structure 710 system structure includes a network layer 720. The network layer 720 includes a telecom switch 724, mobile network 750 used to transact communication links and data exchange with a mobile switching center (MSC) 755 and a user telephone handset 340 using the handset application 770 and a user internet 740 connection. The network layer 720 includes a telecom rules server 728 to manage the processing with the public switched telephone network (PSTN) 700.

The data channel telephone network automated structure 710 system includes an application layer 730 including a rules manager 732, mobility manager 734 and web manager 736. The web manager 736 is used to process internet 740 transactions using a web portal 780 including the user handset, a user digital device with the data channel telephone application installed including a computer, laptop computer, IPad, tablet, IPod 790 of one embodiment.

Handset Application:

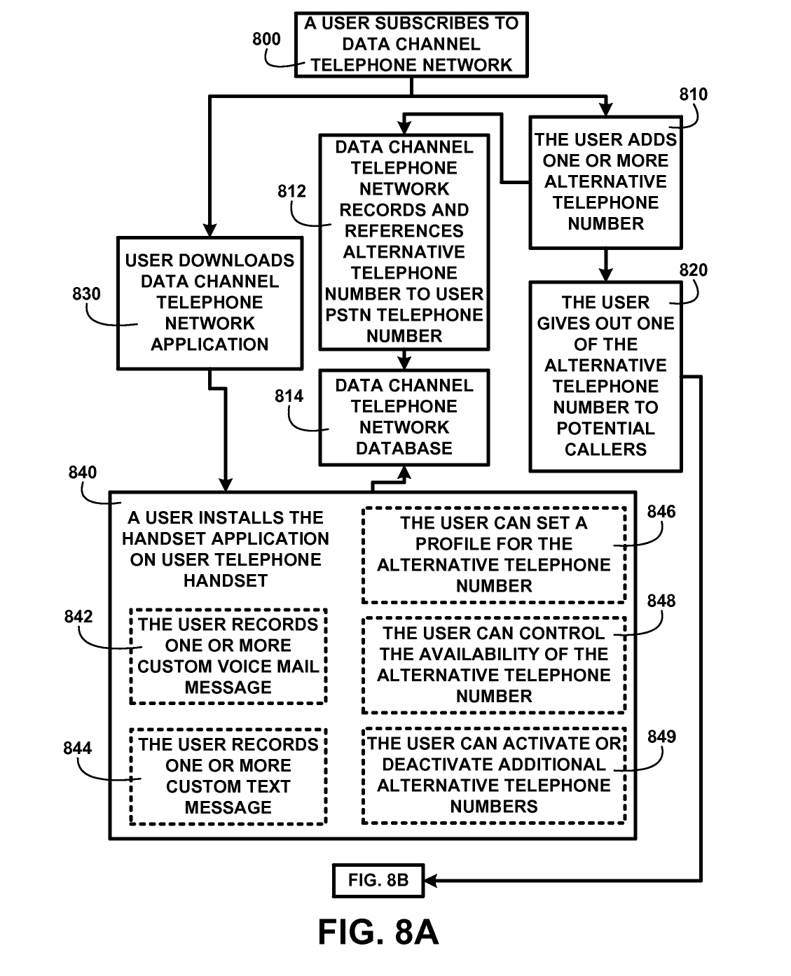

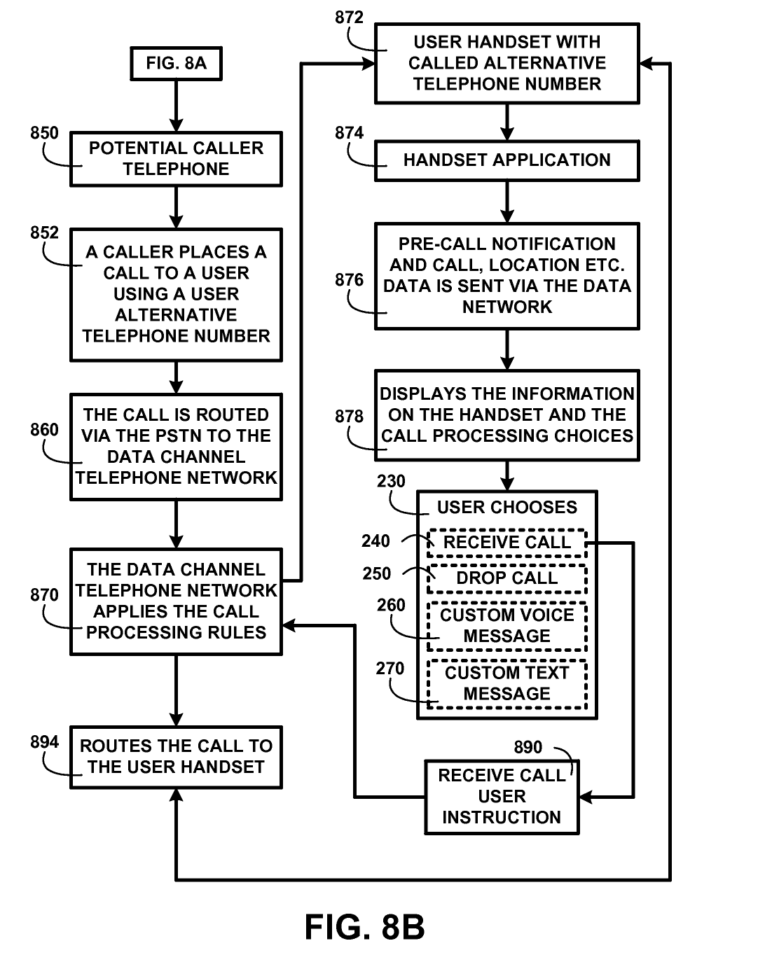

FIG. 8A shows a block diagram of an overview flow chart of handset application of one embodiment. FIG. 8A shows a user subscribes to data channel telephone network 800 and the user adds one or more alternative telephone number 810. The data channel telephone network records and references alternative telephone number to user PSTN telephone number 812. A user downloads Data channel telephone network application 830. The user adds one or more alternative telephone number 810. The user gives out one of the alternative telephone number to potential callers 820. The processing of a call from a potential caller to the user handset alternative telephone number is described in FIG. 8B of one embodiment.

The data channel telephone network records and references alternative telephone number to user PSTN telephone number 812 in a data channel telephone network database 814. When a user downloads Data channel telephone network application 830 a user installs the handset application on user telephone handset 840. Using the handset application the user records one or more custom voice mail message 842, the user records one or more custom text message 844 and the user can set a profile for the alternative telephone number 846. The user can control the availability of the alternative telephone number 848 and the user can activate or deactivate additional alternative telephone numbers 849. The one or more custom voice mail message, one or more custom text message, user profile, availability of the alternative telephone number and user instructions to activate or deactivate additional alternative telephone numbers are recorded and stored on the data channel telephone network database 814 of one embodiment.

Call Processing User Choices:

FIG. 8B shows a block diagram of an overview flow chart of call processing user choices of one embodiment. FIG. 8B shows a continuation from FIG. 8A. A potential caller telephone 850 is used wherein a caller places a call to a user using a user alternative telephone number 852. The call is routed via the PSTN to the Data channel telephone network 860. The data channel telephone network applies the call processing rules 870 to the call to a user handset with called alternative telephone number 872. The handset application 874 sends a pre-call notification and call, location etc. data is sent via the data network 876. The handset application 874 displays the information on the handset and the call processing choices 878. A user chooses 230 to receive call 240, drop call 250, play a custom voice mail message 260 or send a custom text message 270. For example a user chooses to receive call 882. Upon receipt of the receive call user instruction 890 the Data channel telephone network applies the call processing rules 870 and routes the call to the user handset 894 of one embodiment.

Provisioning of Service:

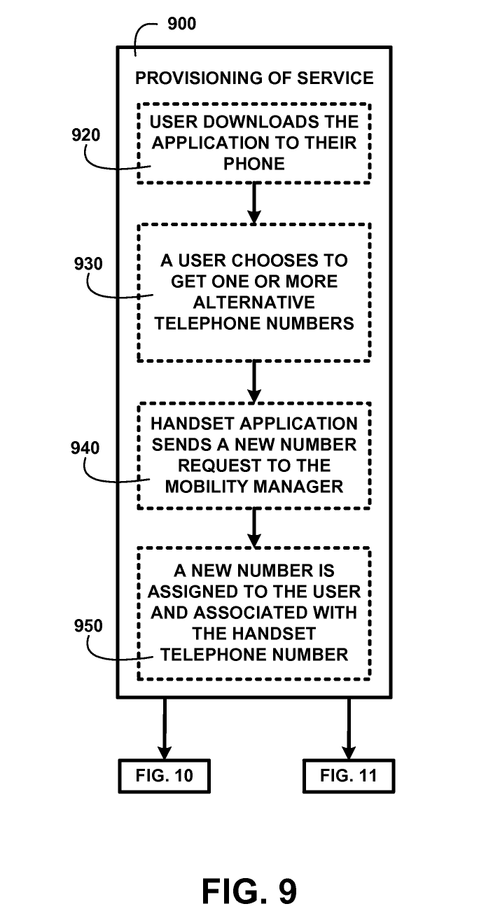

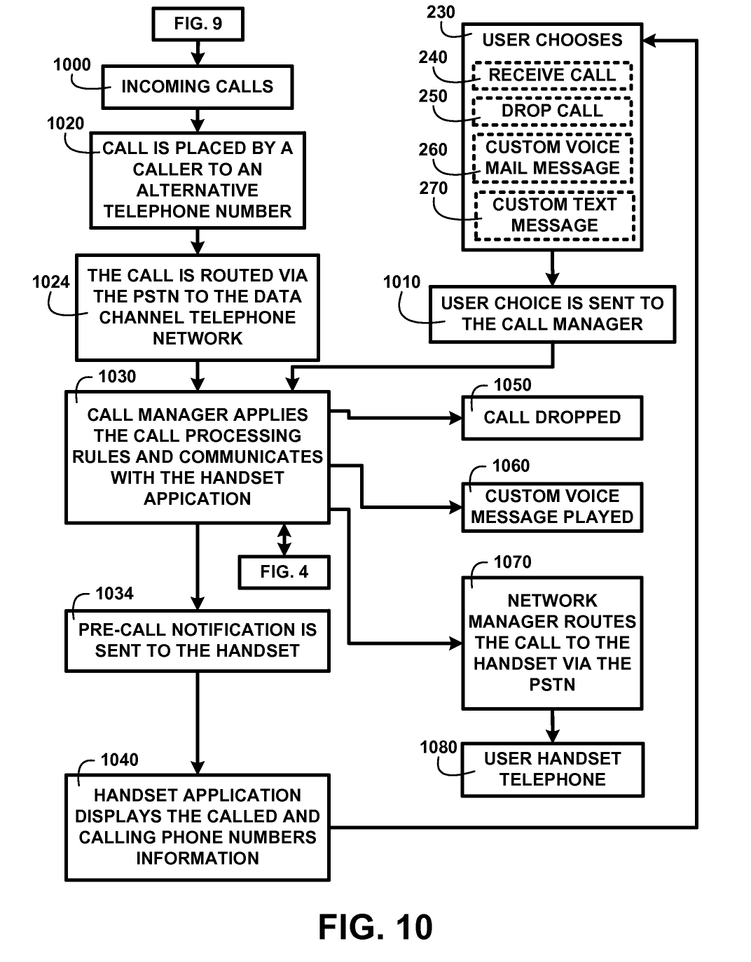

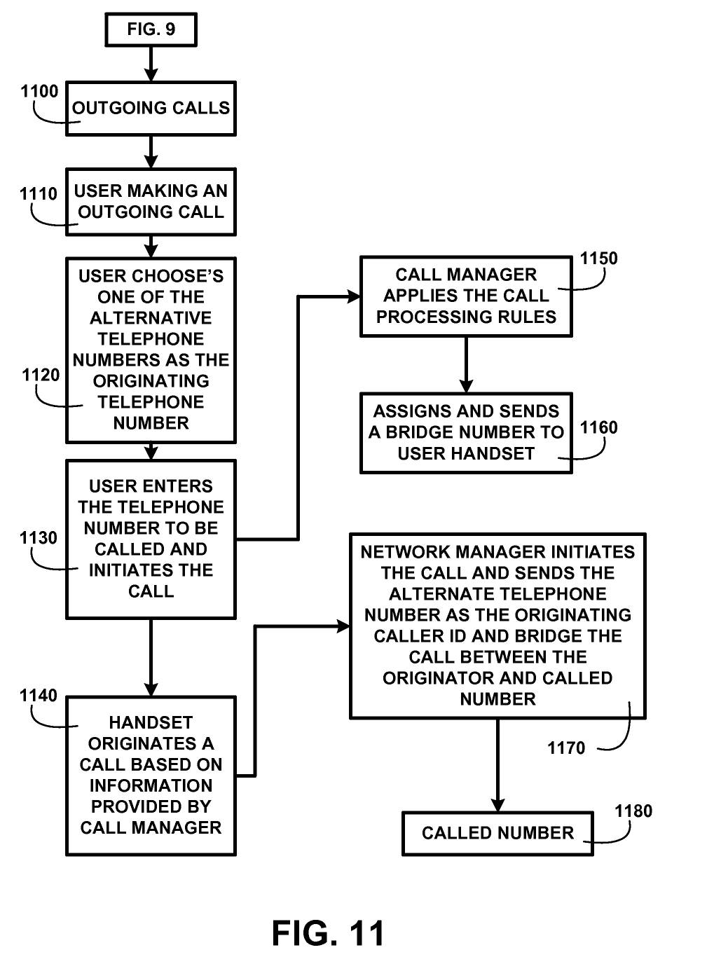

FIG. 9 shows a block diagram of an overview flow chart of provisioning of service of one embodiment. FIG. 9 shows provisioning of service 900. The provisioning of service 900 includes a service wherein a user downloads the application to their phone 920. A user chooses to get one or more alternative telephone numbers 930 and the handset application sends a new number request to the mobility manager 940. A new number is assigned to the user and associated with the handset telephone number 950. Processing of incoming and outgoing calls is described in FIG. 10 and FIG. 11 of one embodiment.

Incoming Calls:

FIG. 10 shows a block diagram of an overview flow chart of incoming calls of one embodiment. FIG. 10 shows the processing of incoming calls 1000 using services described in FIG. 9. A call is placed by a caller to an alternative telephone number 1020. The call is routed via the PSTN to the Data channel telephone network 1024. The call manager applies the call processing rules and communicates with the handset application 1030 as described in FIG. 4. A pre-call notification is sent to the handset 1034. The handset application displays the called and calling phone numbers information 1040. A user chooses 230 from the choices to receive call 240, drop call 250, play a custom voice mail message 260 or send a custom text message 270. A user choice is sent to the call manager 1010. The call manager applies the call processing rules and communicates with the handset application 1030 to display a call dropped 1050 or a custom voice message played 1060. The network manager routes the call to the handset via the PSTN 1070 using the user handset telephone 1080 of one embodiment.

Outgoing Calls:

FIG. 11 shows a block diagram of an overview flow chart of outgoing calls of one embodiment. FIG. 11 shows a continuation from FIG. 9 showing the processing of outgoing calls 1100. A user making an outgoing call 1110 includes user chooses one of the alternative telephone numbers as the originating telephone number 1120. A user enters the telephone number to be called and initiates the call 1130. The call manager applies the call processing rules 1150 and assigns and sends a bridge number to user handset 1160. A handset originates a call based on information provided by call manager 1140. The network manager initiates the call and sends the alternate telephone number as the originating caller ID and bridge the call between the originator and called number 1170 for a call to a called number 1180 of one embodiment.

Handset Application Custom Voice Mail Features:

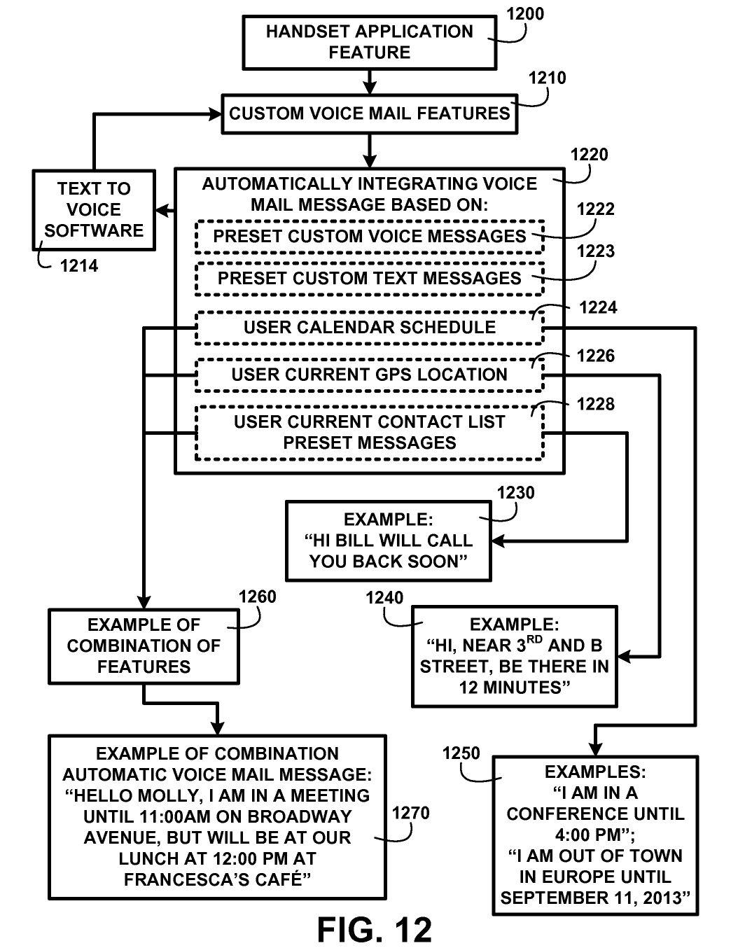

FIG. 12 shows a block diagram of an overview flow chart of handset application custom voice mail features of one embodiment. FIG. 12 shows an example of a handset application feature 1200 including custom voice mail features 1210. The custom voice mail features 1210 includes automatically integrating voice mail message based on: 1220 preset custom voice messages 1222, preset custom text messages 1223, user calendar schedule 1224, user current GPS location 1226 and user current contact list preset messages 1228. The custom voice mail features 1210 includes the use of text to voice software 1214 to convey the voice mail message in a synthesized voice of one embodiment.

Automatically integrating voice mail message includes the following examples. The user calendar schedule 1224 examples: 1250, “I am in a conference until 4:00 pm”; “I am out of town in Europe until Sep. 11, 2013”. Another example using a user current GPS location 1226 includes example: 1240 “Hi, near 3rd and B Street, be there in 12 minutes”. The custom voice mail features 1210 is configured to determine the user travel speed by changes in the GPS location over a period of time, query a mapping website to determine the approximate distance to be traveled to the destination using its GPS location and querying a traffic condition website to factor in any slowing or delays due to current traffic conditions. A further example uses the user current contact list preset messages 1228 for example: 1230 “Hi Bill will call you back soon” wherein the user contact list and/or the caller ID is used to get the caller name of one embodiment.

Automatically integrating voice mail message includes combining information using for example the user calendar schedule 1224, user current GPS location 1226 and user current contact list preset messages 1228. An example of combination of features 1260 includes this example of combination automatic voice mail message: 1270 “Hello Molly, I am in a meeting until 11:00 am on the Broadway Avenue, but will be at our lunch at 12:00 pm at Francesca's Café”. The user handset application custom voice mail features 1210 relieves the user of answering a call for example while driving or while in a meeting and still communicating detailed information to a caller as to their status and availability of one embodiment.

Commercial Entity Provisioning of Service:

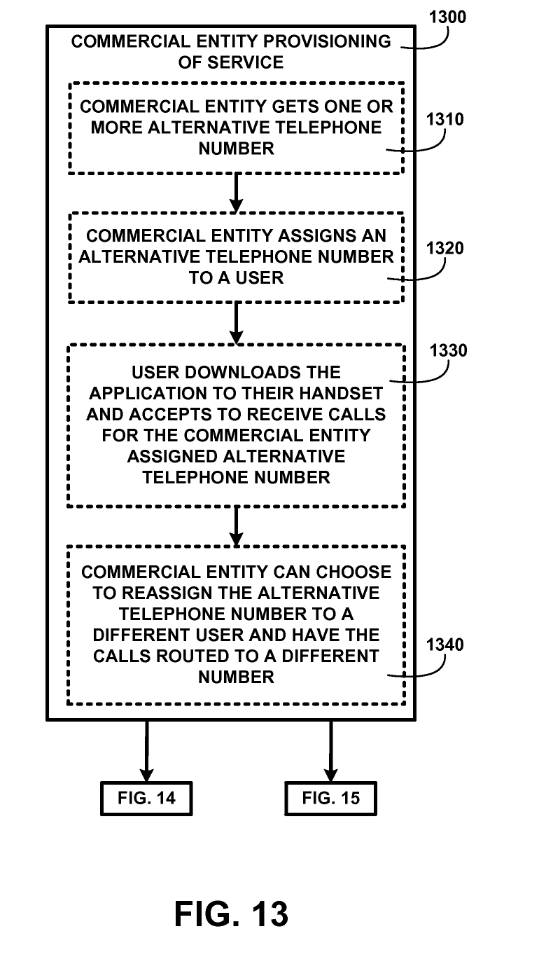

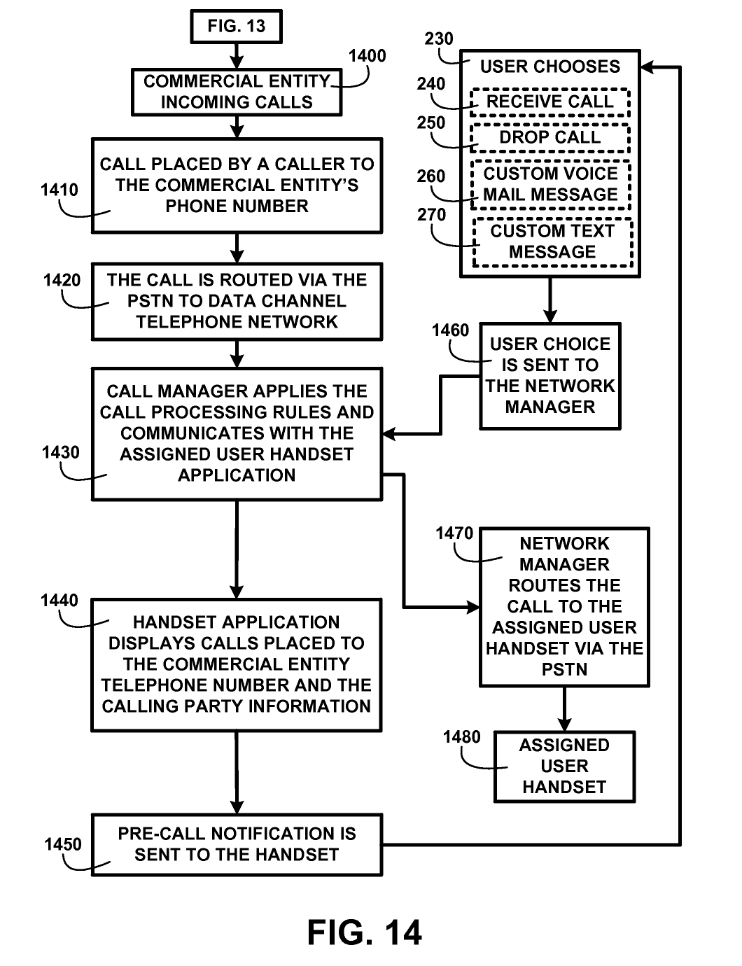

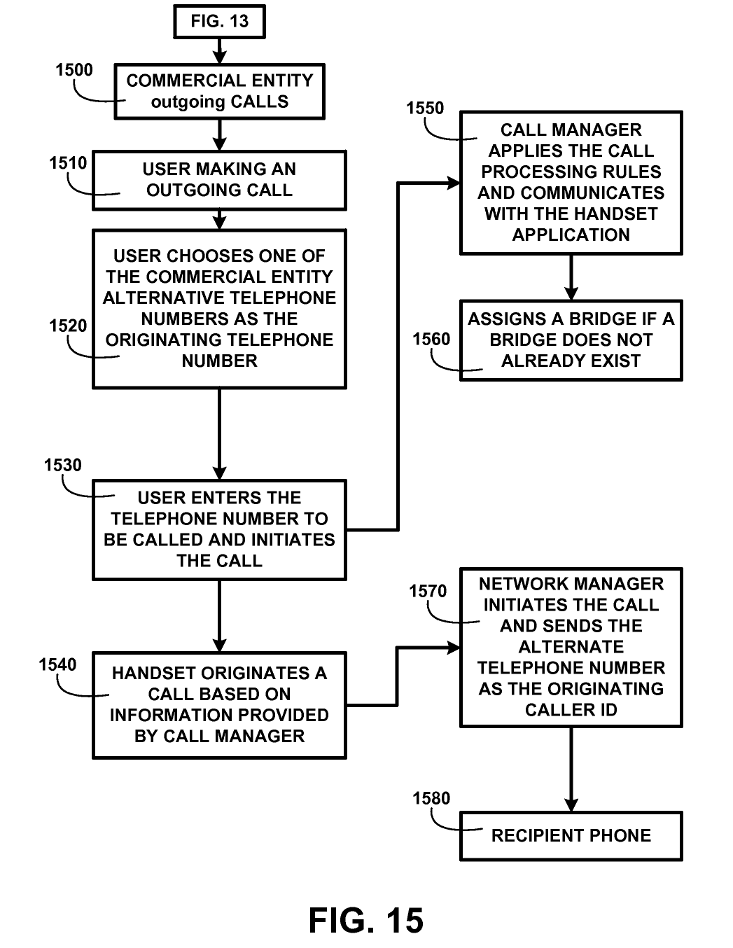

FIG. 13 shows a block diagram of an overview flow chart of commercial entity provisioning of service of one embodiment. FIG. 13 shows a commercial entity provisioning of service 1300 wherein a commercial entity gets one or more alternative telephone number 1310. The commercial entity assigns an alternative telephone number to a user 1320. A user downloads the application to their handset and accepts to receive calls for the commercial entity assigned alternative telephone number 1330. The commercial entity can choose to reassign the alternative telephone number to a different user and have the calls routed to a different number 1340. The processing of incoming and outgoing calls is shown in FIG. 14 and FIG. 15 of one embodiment.

Commercial Entity Incoming Calls:

FIG. 14 shows a block diagram of an overview flow chart of commercial entity incoming calls of one embodiment. FIG. 14 shows continuing from FIG. 13 incoming calls 1400 processing. A call placed by a caller to the commercial entity's phone number 1410 wherein the call is routed via the PSTN to data channel telephone network 1420. The call manager applies the call processing rules and communicates with the assigned user handset application 1430. The handset application displays calls placed to the commercial entity telephone number and the calling party information 1440. The pre-call notification is sent to the handset 1450. The user chooses 230 to receive call 240 or to drop call 250 or to play a custom voice mail message 260 or send a custom text message 270. A user choice is sent to the network manager 1460. The call manager applies the call processing rules and communicates with the assigned user handset application 1430. The network manager routes the call to the assigned user handset via the PSTN 1470 to connect the call to the assigned user handset 1480 of one embodiment.

Commercial Entity Outgoing Calls:

FIG. 15 shows a block diagram of an overview flow chart of commercial entity outgoing calls of one embodiment. FIG. 15 shows a continuation from FIG. 13 for outgoing calls 1500. A user making an outgoing call 1510 wherein the user chooses one of the commercial entity alternative telephone numbers as the originating telephone number 1520. The user enters the telephone number to be called and initiates the call 1530. The call manager applies the call processing rules and communicates with the handset application 1550 which assigns a bridge if a bridge does not already exist 1560. The handset originates a call based on information provided by call manager 1540. The network manager initiates the call and sends the alternate telephone number as the originating caller ID 1570 to a recipient phone 1580 of one embodiment.

Assignable Multiple Alternative Telephone Number Calling Features:

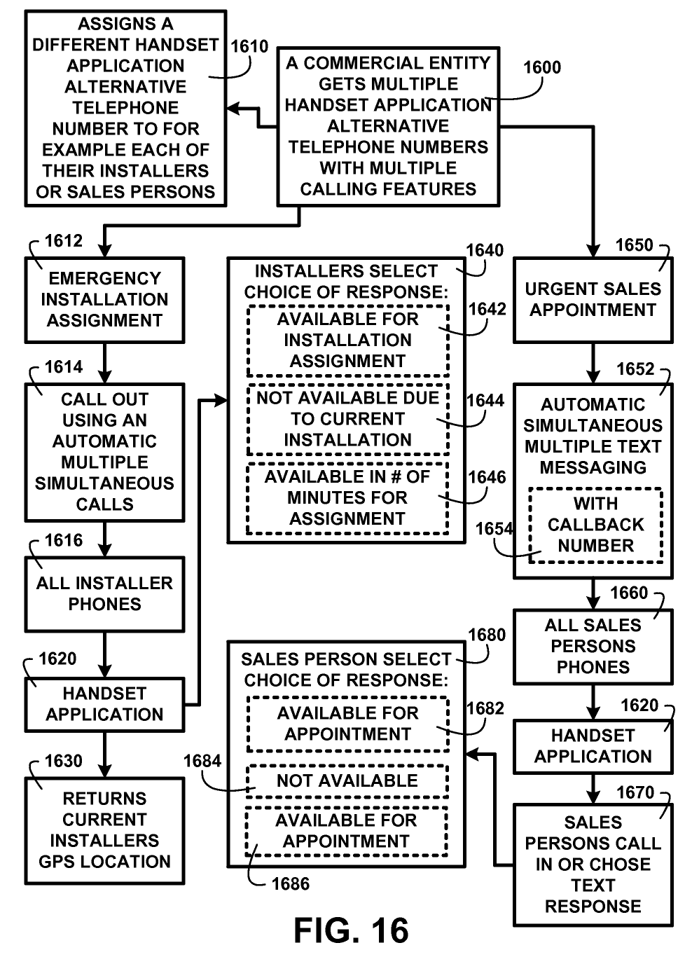

FIG. 16 shows a block diagram of an overview flow chart of commercial entity assignable multiple alternative telephone number calling features of one embodiment. FIG. 16 shows a commercial entity get multiple handset application alternative telephone numbers with multiple calling features 1600 wherein a commercial user assigns a different handset application alternative telephone number to for example each of their installers or sales persons 1610. For example the commercial user has an emergency installation assignment 1612. The commercial user can call out using an automatic multiple simultaneous calls 1614 to all installer phones 1616. The handset application 1620 returns current installers GPS location 1630. The installers select choice of response: 1640 including available for installation assignment 1642, not available due to current installation 1644 and available in # of minutes for assignment 1646.

Another example is a commercial user has an urgent sales appointment 1650. The commercial user can use automatic simultaneous multiple text messaging 1652 with callback number 1654 to communicate the appointment to all sales persons phones 1660. The handset application 1620 enables sales persons call in or chose text response 1670. For example a sales person select choice of response: 1680 including available for appointment 1682, not available 1684 and available for appointment 1686 of one embodiment.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method of a data channel telephone network system, comprising:
enrolling a user subscribing to a data channel telephone network system;
installing a data channel telephone network application on user telephone handset;
using the data channel telephone network application to record and store user selectable and configurable call processing rules on the network database;
routing incoming and outgoing calls via a public switched telephone network to the data channel telephone network system using the user configured call processing rules; and
displaying choices the user can choose from to process how to handle an incoming call response using user configured call processing rules, user preset responses and data channel telephone network application automated features.

2. The method of claim 1, wherein the data channel telephone network application can be downloaded from the data channel telephone network and an automated installation feature can be used to install the data channel telephone network application on user telephone handset including adding one or more user alternative telephone number referenced to user telephone number when enrolled.

3. The method of claim 1, wherein the user configured call processing rules includes incoming call processing user choices including to receive call, drop a call, play a prerecorded custom voice mail message, send a preset custom text message and recording and storing the user configured call processing rules, user information and user alternative telephone numbers on a data channel telephone network database.

4. The method of claim 1, wherein one or more user alternative telephone number includes a feature wherein a user can temporarily assign each alternative telephone number independently to a different user telephone number for a specific purpose or period of time.

5. The method of claim 1, further comprising network application automated features including conference calling, simultaneous automated multiple calling, presetting lists of acceptable and unacceptable incoming call processing rules to receive or drop calls without user interaction and displaying an incoming pre-call information notification on the user telephone handset using the network application before or during the incoming call ringing.

6. The method of claim 1, further comprising network application automated features including recording one or more user custom voice mail message, inputting one or more user custom text message, setting a user profile for each alternative telephone number, a user controlling the availability of each alternative telephone number and wherein the user can activate or deactivate additional alternative telephone numbers individually.

7. The method of claim 1, wherein the call processing rules includes call routing based on location data, based on incoming caller id, a user accepted caller ID list always routes the call, a user non-accepted caller ID list never routes the call, based on weekday, weekend, holidays and time of day, an interface with a user calendar to check availability to accept calls including Outlook, Google Calendar and other user calendars.

8. The call processing rules of claim 7, wherein the network application automated features are configured to include a text to voice system to convey a custom text message in a synthesized voice.

9. The method of claim 1, wherein the network application automated features are configured to include assignable multiple alternative telephone number calling features.

10. The method of claim 1, wherein the network application automated features are configured to include automatically integrating a voice mail message based on preset custom voice messages, user calendar schedule, user current GPS location and user current contact list preset messages.

11. A network application for processing calls on a user telephone handset to automate managing telephone calls and text messaging, comprising:
means for downloading a digital application downloadable wherein the digital application can be installed on a user telephone handset;
means for establishing a wireless connection between the digital application installed on the user telephone handset and a data channel telephone network system used to identify and process incoming and outgoing calls to one or more alternative telephone numbers referenced to user telephone number;
means for incorporating one or more automated features integrated into the digital application wherein the user can setup user call processing rules and select from the user call processing rules to manage responses to calls using user preset responses; and
means for customizing automated digital application features to enable processing multiple alternative telephone numbers simultaneously using a call distribution algorithm and other user features.

12. The network application of claim 11, further comprising means for customizing a conference calling feature including automated polling of conference call participants to confirm their participation in the conference call including displaying participant choices on participant telephones and automated reporting of status responses to a user host.

13. The network application of claim 11, further comprising means for customizing voice mail features including user selectable prerecorded voice mail messages.

14. The network application of claim 11, further comprising means for using text to voice software to convey a custom text message feature in a synthesized voice.

15. The network application of claim 11, further comprising means for automatically integrating a voice mail message based on preset custom voice messages, user calendar schedule, user current GPS location and user current contact list preset messages.

16. A data channel telephone network system automated interface structure, comprising:
an automated interface used for capturing incoming telephone calls caller information via a mobile number portability database and routed to a user alternative telephone number;
an automated interface used for displaying the caller information in a pre-notification of the incoming call information on a user telephone handset using a data channel telephone system digital network application installed on the user telephone handset;
an automated interface used for processing user call processing rules to a public switched telephone network;
an automated interface used for processing one or more alternative telephone number referenced to a user telephone number using a data channel telephone network system database and a call distribution algorithm; and
one or more digital application features installed on a user telephone handset to automatically filter incoming calls using the user call processing rules.

17. The data channel telephone network system automated interface structure of claim 16, wherein automated interface used for capturing incoming telephone calls caller information is configured to capture data from a Signaling System No. 7 (SS7).

18. The data channel telephone network system automated interface structure of claim 16, further comprising a network layer configured to include a telecom switch to process calls to a public switched telephone network and a telecom rules server.

19. The data channel telephone network system automated interface structure of claim 16, further comprising an application layer configured to include a rules manager, a mobility manager and a web manager.

20. The web manager of claim 19, wherein the web manager is configured to process internet transactions using a web portal including the user handset, a user digital device with the data channel telephone application installed including a computer, laptop computer, IPad, tablet and IPod.
